(19) United States
(12) Patent Application Publication
(10) Pub. No.: US 2025/0247926 A1
(43) Pub. Date: Jul. 31, 2025

(54) MICROWAVE DEVICE

(71) Applicant: MICROELECTRONICS TECHNOLOGY, INC., HSINCHU (TW)

(72) Inventors: Ming-Che LIOU, HSINCHU CITY (TW); Huan-Chieh TSENG, HSINCHU (TW); Chia Lun LIU, HSINCHU (TW)

(21) Appl. No.: 18/428,311

(22) Filed: Jan. 31, 2024

(51) Int. Cl. H05B 6/68; H05B 6/66; H05B 6/70

(52) U.S. Cl. CPC H05B 6/686; H05B 6/664; H05B 6/70

(57) ABSTRACT

The present disclosure provides a microwave device including a master generator, delay lines, and slave generators. The master generator is configured to generate a source RF signal so as to generate a master RF output. The delay lines are coupled to the master generator. The lave generators are coupled to the master generator through the delay lines and configured to generate slave RF outputs according to the source RF signal, respectively. The master RF output and the plurality of slave RF outputs are in phase.

### TECHNICAL FIELD

The present disclosure relates to a microwave device, and more particularly, to a microwave device using solid state microwave generators.

### DISCUSSION OF THE BACKGROUND

In the field of microwave irradiation, the magnetron tube are typically used for the microwave source. Although the magnetron tube can generate the microwave with high power, the microwave generated by the magnetron tube usually includes various of resonance wavelengths, which result that the controllability of these microwave is not optimal. Therefore, there is a need to perform a microwave generation with high power and better controllability.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides a microwave device including a master generator, delay lines, and slave generators. The master generator is configured to generate a source radio frequency (RF) signal so as to generate a master RF output. The delay lines are coupled to the master generator. The slave generators are coupled to the master generator through the delay lines and configured to generate slave RF outputs according to the source RF signal, respectively. The master RF output and the plurality of slave RF outputs are in phase.

In some embodiments, each of the delay lines has a length equal to each other. In some embodiments, each of the delay lines has equal electrical length.

In some embodiments, the master generator includes a phase-locked loop (PLL) synthesizer, a splitter, a delay unit, a master phase shifter, a master attenuator, and a master amplifier. The PLL synthesizer is configured to generate the source RF signal. The splitter is configured to split the source RF signal, and to generate a master RF signal and slave RF signals. The delay unit is configured delay the master RF signal so as to generate a delayed master RF signal. The master phase shifter is configured adjust a phase of the delayed master RF signal so as to generate an adjusted RF signal. The master attenuator is configured to attenuate a power of the adjusted RF signal so as to generate an attenuated RF signal. The master amplifier is configured to amplify the attenuated RF signal so as to generate the master RF output.

In some embodiments, the delay lines are coupled to the splitter, and configured to delay the slave RF signals so as to generate a delayed slave RF signals, respectively. The slave generators is configured to receive the delayed slave RF signals, respectively.

In some embodiments, the delay master RF signal and each of the delayed slave RF signals are in phase.

In some embodiments, each of the slave generators includes a slave phase shifter, a slave attenuator, and a slave amplifier. The slave phase shifter is coupled to the respective delay line and configured to generate an adjusted slave RF signal according to the respective slave RF signal. The slave attenuator is configured to attenuate a power of the adjusted slave RF signal so as to generate an attenuated slave RF signal. The slave amplifier is configured to amplify the attenuated slave RF signal so as to generate the respective slave RF output.

In some embodiments, the splitter includes a power control unit and a coupler. The power control unit is configured to receive the source RF signal and control a power of the source RF signal. The coupler is coupled to the power control unit, and configured to generate the slave RF signals.

In some embodiments, the power control unit includes an attenuator and an amplifier. The attenuator is configured to receive the source RF signal. The amplifier is coupled between the attenuator and the coupler.

In some embodiments, a power of the master RF output is identical to a power of each of the slave RF outputs.

Another aspect of the present disclosure provides a microwave device including a master generator, an external delay line, delay lines, and slave generators. The master generator is configured to generate split signals and generate a master RF output. The external delay line is coupled to the master generator. The delay lines are coupled to the master generator. The slave generators are coupled to the master generator through the delay lines and configured to generate slave RF outputs according to a source RF signal, respectively. The master generator is configured to receive a first split signal of the split signals so as to generate the master RF output, and the slave generators are configured to receive the rest of the split signals other than the first split signal so as to generate the slave RF output, respectively.

Yet another aspect of the present disclosure provides a microwave device including a master generator, a splitter, delay lines, and slave generators. The master generator is configured to generate a source RF signal. The splitter is coupled to split the source RF signal to split signals. The delay lines are configured to delay the split signals so as to generate delayed signals. The delayed signals includes a master RF signal and slave RF signals. The master generator is configured to generate a master RF output according to the master RF signal, and the slave generators are respectively configured to generate slave RF outputs according to the slave RF signals. Each of the delay lines has an electrical length equal to each other.

In some embodiments, the master RF output and the slave RF outputs are in phase.

In some embodiments, the master generator includes a PPL synthesizer, a master phase shifter, a master attenuator, and a master amplifier. The PLL synthesizer is configured to generate the source RF signal. The master phase shifter is configured adjust a phase of the master RF signal so as to generate an adjusted RF signal. The master attenuator is configured to attenuate a power of the adjusted RF signal so as to generate an attenuated RF signal. The master amplifier is configured to amplify the attenuated RF signal so as to generate the master RF output.

In some embodiments, each of the slave generators includes a slave phase shifter, a slave attenuator, and a slave amplifier. The slave phase shifter is configured to generate an adjusted slave RF signal according to the respective slave RF signal. The slave attenuator is configured to attenuate a power of the adjusted slave RF signal so as to generate an attenuated slave RF signal. The slave amplifier is configured to amplify the attenuated slave RF signal so as to generate the respective slave RF output.

In some embodiments, the microwave device further includes a controller configured to control the slave phase shifter of each of the slave generators so as to adjust a phase of each of the adjusted slave RF signal.

In some embodiments, the microwave device is configured to perform a beam forming to irradiate the master RF output and the slave RF outputs along a direction.

In some embodiments, the direction of beam forming is associated with a phase of the master RF output and a phase of each of the slave RF outputs.

In some embodiments, each of the split signals has a power equal to each other.

In some embodiments, each of the split signals has a power equal to a power of the source RF signal.

In some embodiments, the master generator and the slave generators are solid state microwave generators.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 is a schematic diagram of a microwave device according to some embodiments of the present disclosure.

FIG. 2 is a schematic diagram of the microwave device shown in FIG. 1 according to some embodiments of the present disclosure.

FIG. 3 is a schematic diagram of a master generator according to some embodiments of the present disclosure.

FIG. 4 is a schematic diagram of a slave generator according to some embodiments of the present disclosure.

FIG. 5 is a schematic diagram of a splitter according to some embodiments of the present disclosure.

FIG. 6 is a schematic diagram of a splitter according to other embodiments of the present disclosure.

FIG. 7 is a schematic diagram of a splitter according to various embodiments of the present disclosure.

FIG. 8 is a schematic diagram of a splitter according alternative embodiments of the present disclosure.

FIG. 9 is a schematic diagram of a microwave device according to some embodiments of the present disclosure.

FIG. 10 is a schematic diagram of a master generator according to some embodiments of the present disclosure.

FIG. 11 is a schematic diagram of a microwave device according to some embodiments of the present disclosure.

FIG. 12 is a schematic diagram of a master generator according to some embodiments of the present disclosure.

FIG. 13 is a schematic diagram of a microwave device according to other embodiments of the present disclosure.

FIG. 14 is a schematic diagram of a microwave device according to some embodiments of the present disclosure.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another element, component, region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limiting to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

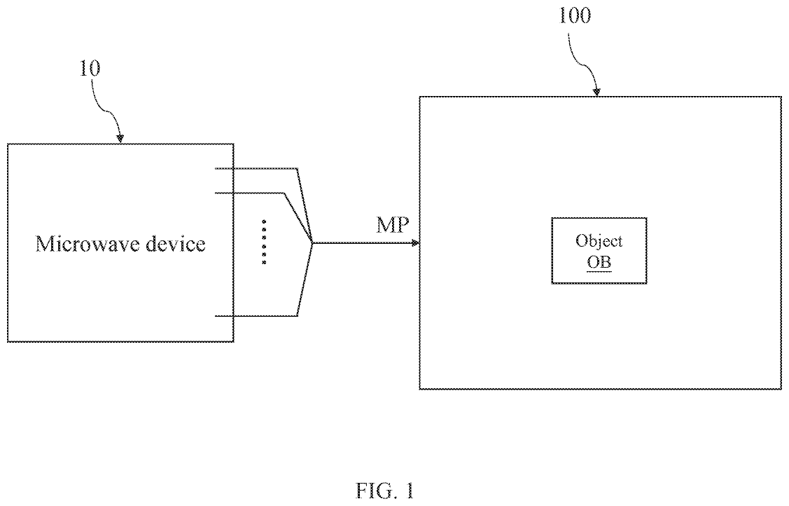

Reference is made to FIG. 1. FIG. 1 is a schematic diagram of a microwave device 10 according to some embodiments of the present disclosure. The microwave device 10 is configured to irradiate a microwave power MP to heat an object OB. The object is illustrated in a chamber 100, i.e., in a closed space, however, the present disclosure is not limited thereto. The object OB can be disposed in an open space other than a closed space. In some embodiments, when the microwave device 10 irradiates the microwave power MP, the microwave device 10 performs a beam forming to stack up several microwaves so as to generate the microwave power MP having a power substantially equal to a sum of the power of these microwaves.

In some embodiments, the microwave device 10 is configured to generate the microwave power MP having a power in a range about Kilo-watt (KW) to about Mega-watt (MW).

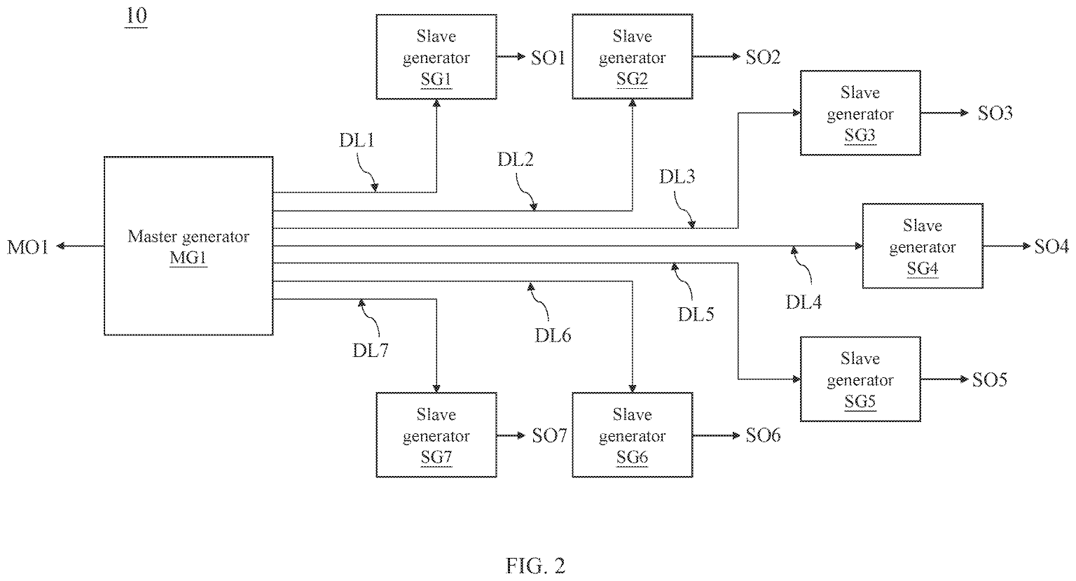

Reference is made to FIG. 2. FIG. 2 is a schematic diagram of the microwave device 10 according to some embodiments of the present disclosure. The microwave device 10 includes a master generator MG1, slave generators SG1 to SG7, and delay lines DL1 to DL7. The slave generators SG1 to SG7 are coupled to the master generator MG1 through the delay lines DL1 to DL7, respectively.

The master generator MG1 is configured to generate a master radio frequency (RF) output MO1, and the slave generators SG1 to SG7 are configured to generate slave RF outputs SO1 to SO7, respectively.

In some embodiments, the microwave device 10 is configured to perform the beam forming to stack up the master RF output MO1 and the slave RF output SO1 to SO7, so as to generate the microwave power MP.

The delay lines DL1 to DL7 are also known as delay cables. In some embodiments, each of the delay lines DL1 to DL7 has a length equal to each other. In some embodiments, the master RF output MO1 and the slave RF outputs SO1 to SO7 are identical. More specifically, a frequency, a phase, and a power of the master RF output MO1 are the same as a frequency, a phase, and a power of each of the slave RF outputs SO1 to SO7. In other words, the master RF output MO1 and the slave RF outputs SO1 to SO7 are synchronized.

The microwave device 10 performs the beam forming according to the master RF output MO1 and the slave RF outputs SO1 to SO7, so as to generate the microwave power MP. In some embodiments, because the frequency and the phase of each of the master RF output MO1 and the slave RF outputs SO1 to SO7 are the same, a power of the microwave power MP is substantially equally to a sum of the power of the master RF outputs and the slave RF outputs SO1 to SO7.

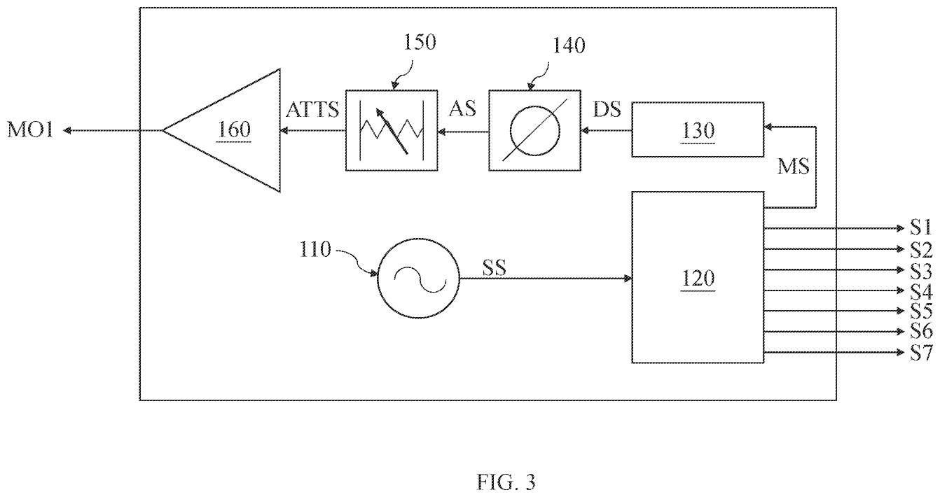

Reference is made to FIG. 3. FIG. 3 is a schematic diagram of the master generator MG1 according to some embodiments of the present disclosure. The master generator MG1 includes a phase-locked loop (PLL) synthesizer 110, a splitter 120, a delay unit 130, a phase shifter 140, an attenuator 150, and an amplifier 160.

The PLL synthesizer 110 is configured to generate a source RF signal SS. The splitter 120 is configured to receive the source RF signal SS and generate a master RF signal MS and slave RF signals S1 to S7 by splitting the source RF signal SS.

In some embodiments, a frequency of the source RF signal SS is identical to a frequency of the master RF signal MS and a frequency of each of the slave RF signals S1 to S7, and a power of the source RF signal SS is identical to a power of the master RF signal MS and a power of each of the slave RF signals S1 to S7. Furthermore, the master RF signal MS and each of the slave RF signals S1 to S7 are in phase.

The delay unit 130 is configured to receive the master RF signal MS and generate a delayed master RF signal DS by delaying the master RF signal MS.

The phase shifter 140 is configured to receive the delayed master RF signal DS and generate an adjusted RF signal AS by adjusting a phase of the delayed master RF signal DS. In some embodiments, an amount of phase adjusted by the phase shifter 140 is set to 0 degree, which means that the phase value does not change. In such embodiments, the phase value of the adjusted RF signal AS is set to be a reference phase for other slaver generators SG1 to SG7. Alternatively, the phase shifter 140 has the ability to change the phase of the delayed master RF signal DS and also has the ability to maintain the phase of delayed master RF signal DS.

The attenuator 150 is configured to receive the adjusted RF signal AS and generate an attenuated RF signal ATTS by attenuating a power of the adjusted RF signal AS. The amplifier 160 is configured to receive the attenuated RF signal ATTS and generate the master RF output MO1 by amplifying the attenuated RF signal ATTS.

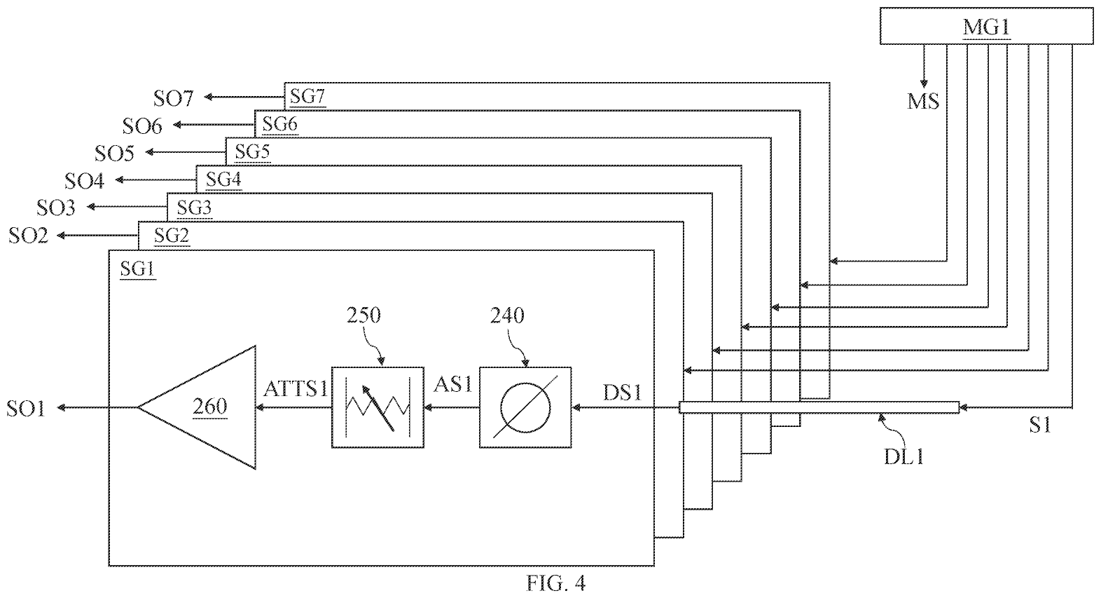

Reference is made to FIG. 4. FIG. 4 is a schematic diagram of the slave generator SG1 according to some embodiments of the present disclosure. In some embodiments, the slave generators SG1 to SG7 are identical to each other, therefore, only the slave generator SG1 is described for the sake of brevity.

The slave generator SG1 is coupled to the master generator MG1 through the delay line DL1. The delay line DL1 receives the slave RF signals S1 and generate a delayed slave RF signal DS1 by delaying the slave RF signal S1. In some embodiments, the delayed slave RF signal DS1 and the delayed master RF signal DS are in phase.

In FIG. 4, although the delayed line DL1 is illustrated using a solid box separated from the master generator MG1 and the slave generator SG1, it should be noted that the delay line DL1 can represent an electrical connection between the splitter 120 of the master generator MG1 and the phase shifter 240 of the slave generator SG1. In other words, the phase delaying can occur at any portion between the splitter 120 of the master generator MG1 and the phase shifter 240 of the slave generator SG1.

In some embodiments, the frequency of the source RF signal SS may be changed. In order to maintain the delayed slave RF signals DS1 to DS7 and the delayed master RF signal DS in phase in different frequency, a length of each of the delay lines DL1 to DL7 is equal to each other, and an effective length of the delay unit 130 is equal to the length of each of the delay lines DL1 to DL7.

The slave generator SG1 includes a phase shifter 240, an attenuator 250, and an amplifier 260.

The phase shifter 240 is configured to receive the delayed slave RF signal DS1 and generate an adjusted slave RF signal AS1 by adjusting a phase of the delayed slave RF signal DS1. Alternatively, the phase shifter 240 has the ability to change the phase of the delayed slave RF signal DS1 and also has the ability to maintain the phase of delayed slave RF signal DS1.

The attenuator 250 is configured to receive the adjusted slave RF signal AS1 and generate an attenuated slave RF signal ATTS1 by attenuating a power of the adjusted slave RF signal AS1. The amplifier 260 is configured to receive the attenuated slave RF signal ATTS1 and generate the slave RF output SO1 by amplifying the attenuated slave RF signal ATTS1.

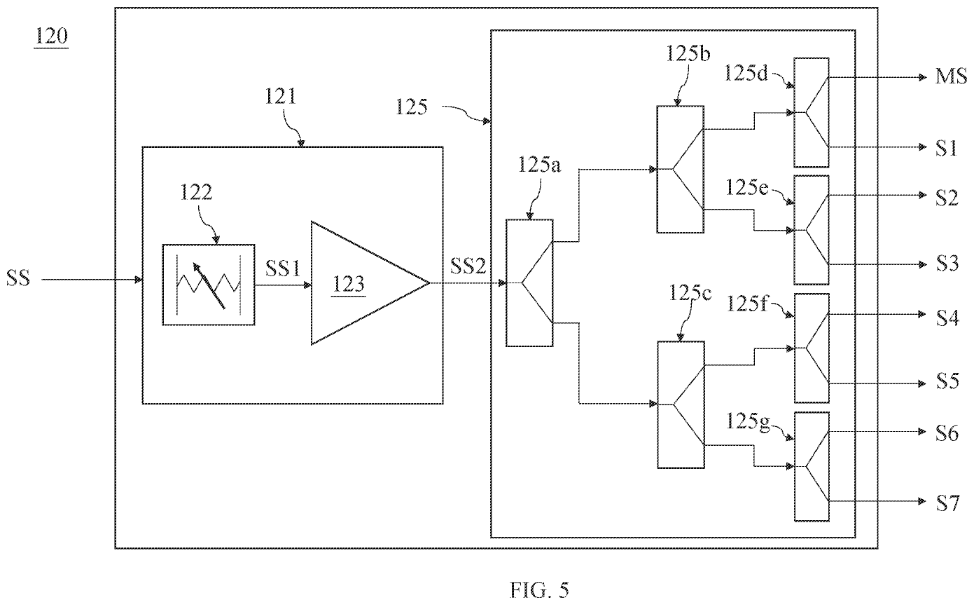

Reference is made to FIG. 5. FIG. 5 is a schematic diagram of the splitter 120 of the master generator MS1 according to some embodiments of the present disclosure.

The splitter 120 includes a power control unit 121 and a coupler assembly array 125. The power control unit 121 is configured to receive the source RF signal SS and control a power of the source RF signal SS. The coupler assembly array 125 is coupled to the power control unit 121 and configured to generate the master RF signal MS and the slave RF signals S1 to S7.

The power control unit 121 includes an attenuator 122 and an amplifier 123. The attenuator 122 is configured to receive the source RF signal SS and generate an attenuated signal SS1 by attenuating a power of the source RF signal SS. The amplifier 123 is configured to amplify the attenuated signal SS1 to generate an amplified signal SS2.

In some embodiments, a gain of the amplifier 123 is set and fixed at a predetermined value. In some embodiments, the gain of the amplifier 123 is set and fixed at the maximum value of the amplifier 123.

As illustrated in and FIG. 3 and FIG. 5, the splitter 120 is configured to output eight signals (MS and S1 to S7), and each signal has equal power. In light of above, the power control unit 121 has to control the power of the amplified signal SS2 at least equal to or eight times greater than the source RF signal SS.

The coupler assembly array 125 is configured to receive the amplified signal SS2, and split the amplified signal SS2 to be the master RF signal MS and the slave RF signals S1 to S7.

In the embodiment shown in FIG. 5, the coupler 125 includes dividers 125a, 125b, 125c, 125d, 125e, 125f, and 125g. Each of the dividers 125a to 125g is configured to split the received signal to two identical signals, in which each of the split signals has half power of the received signal.

The divider 125a is coupled to the power control unit 121 and configured to receive the amplified signal SS2. The divider 125b and the divider 125c are respective coupled to the divider 125a and configured to receive the split signals generated by the divider 125a. The divider 125d and the divider 125e are respective coupled to the divider 125b and configured to receive the split signals generated by the divider 125b. The divider 125d is configured to generate the master RF signal MS and the slave RF signal S1. The divider 125e is configured to generate the slave RF signal S2 and the slave RF signal S3. The divider 125f and the divider 125g are respective coupled to the divider 125c and configured to receive the split signals generated by the divider 125c. The divider 125f is configured to generate the slave RF signal S4 and the slave RF signal S5. The divider 125g is configured to generate the slave RF signal S6 and the slave RF signal S7.

The number of slave RF signals S1 to S7 (i.e., the number of the slave generators) shown in FIG. 2, FIG. 3, and FIG. 5 are provided for illustrative purposes. However, the present disclosure is not limited thereto. In various embodiments, the microwave device 10 includes fewer or more slave generators.

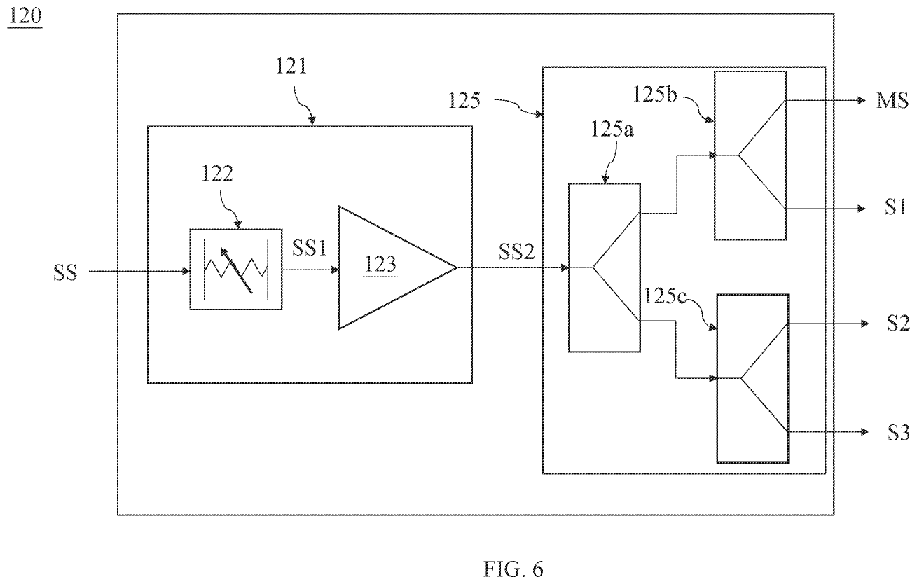

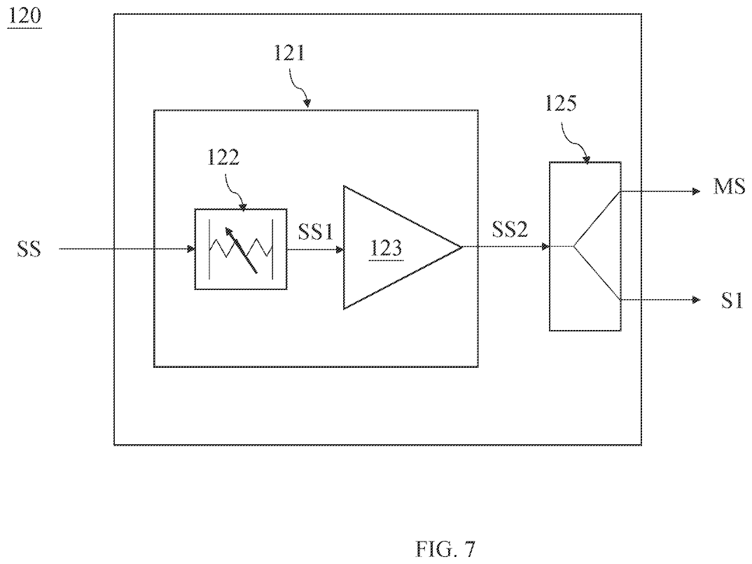

Reference is made to FIG. 6 and FIG. 7. FIG. 6 is a schematic diagram of the splitter 120 according to other embodiments of the present disclosure. FIG. 7 is a schematic diagram of the splitter 120 according to various embodiments of the present disclosure.

When the microwave device 10 includes fewer slave generators, such as 3 slave generators, the coupler assembly array 125 of the splitter 120 is configured to generate 4 outputs. Compared to the coupler assembly array 125 shown in FIG. 5, the dividers 125d to 125g are omitted in the coupler assembly array 125 shown in FIG. 6. As such, the divider 125b is configured to generate the master RF signal MS and the slave RF signal S1, and the divider 125c is configured to generate the slave RF signal S2 and the slave SF signal S3.

When the microwave device 10 includes much fewer slave generators, such as only 1 slave generator, the coupler assembly array 125 of the splitter 120 is configured to generate 2 outputs. Compared to the coupler assembly array 125 shown in FIG. 5, the dividers 125b to 125g are omitted in the coupler assembly array 125 shown in FIG. 7. As such, the coupler assembly array 125 is the divider 125a, and configured to generate the master RF signal MS and the slave RF signal S1.

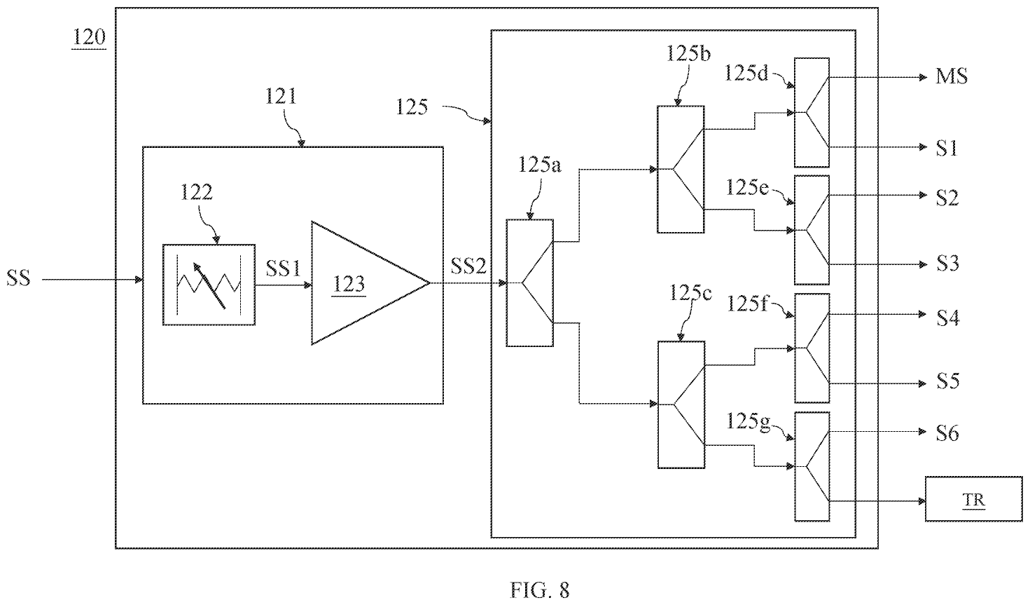

Reference is made to FIG. 8. FIG. 8 is a schematic diagram of the splitter 120 according to alternative embodiments of the present disclosure.

In alternative embodiments, the microwave device 10 includes other number of slave generators, such as 6 slave generator. As such, a terminator TR is used to terminate one of outputs of the splitter 120.

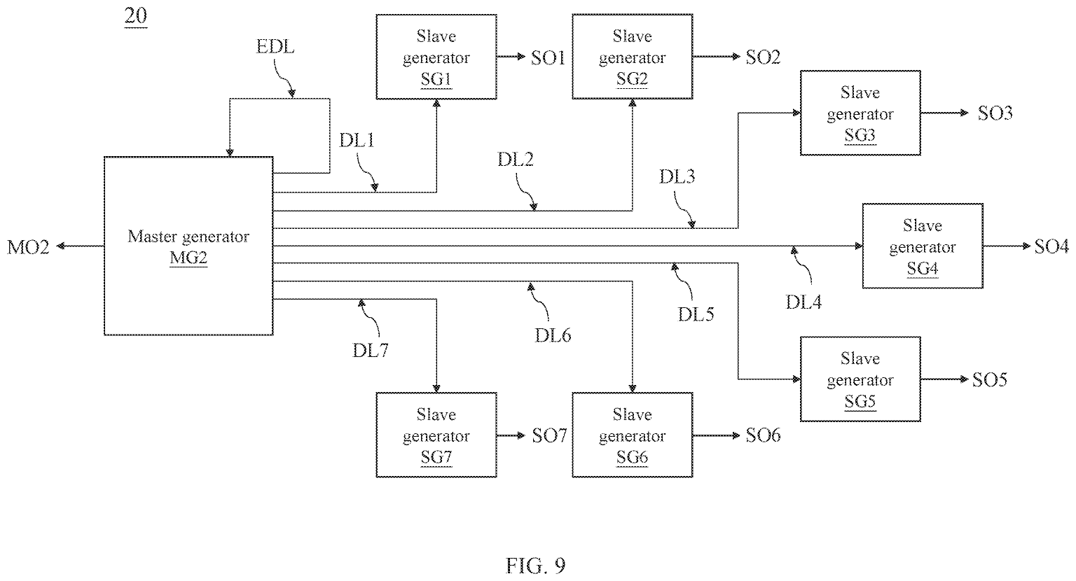

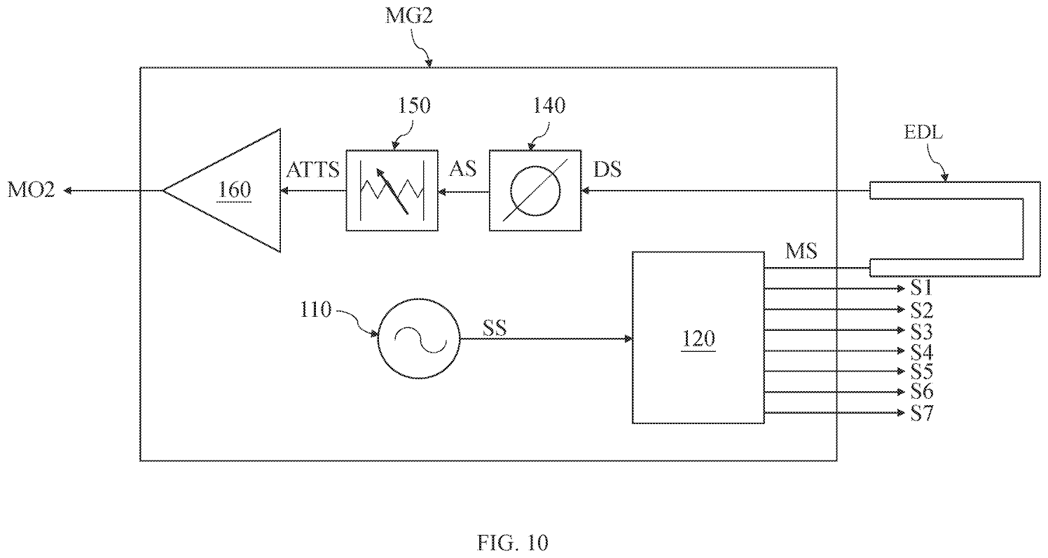

Reference is made to FIG. 9 and FIG. 10. FIG. 9 is a schematic diagram of a microwave device 20 according to some embodiments of the present disclosure. FIG. 10 is a schematic diagram of a master generator MG2 according to some embodiments of the present disclosure.

The microwave device 20 is similar to the microwave device 10. More specifically, the microwave device 20 is configured to irradiate the microwave power MP to the object OB as illustrated in FIG. 1. Compared to the microwave device 10, the microwave device 20 includes a master generator MG2 different from the master generator MG1 and an external delay line EDL coupled to the master generator MG2.

To facilitate understanding, reference numerals of similar components in the microwave device 20 are designated as the same reference numerals of those in the microwave device 10.

Similar to the master generator MG1, the master generator MG2 includes a PLL synthesizer 110, a splitter 120, a phase shifter 140, an attenuator 150, and an amplifier 160.

The PLL synthesizer 110 is configured to generate a source RF signal SS. The splitter 120 is configured to receive the source RF signal SS and generate a master RF signal MS and slave RF signals S1 to S7 by splitting the source RF signal SS.

In some embodiments, a frequency of the source RF signal SS is identical to a frequency of the master RF signal MS and a frequency of each of the slave RF signals S1 to S7, and a power of the source RF signal SS is identical to a power of the master RF signal MS and a power of each of the slave RF signals S1 to S7. Furthermore, the master RF signal MS and each of the slave RF signals S1 to S7 are in phase.

Compared to the master generator MG1, the master generator MG2 does not includes a delay unit 130 therein, instead, the microwave device 20 further includes the external delay line EDL coupled to the master generator MG2.

The external delay line EDL is configured to receive the master RF signal MS and generate a delayed master RF signal DS by delaying the master RF signal MS. The delay lines DL1 to DL7 are configured to delay the slave RF signals S1 to S7 and generate the delayed slave RF signals DS1 to DS7, respectively. The delayed master RF signal DS and the delayed slave RF signals DS1 to DS7 are in phase. In order to maintain the delayed master RF signal DS and the delayed slave RF signals DS1 to DS7 in phase at different frequency, a length of the external delay line EDL and lengths of the delay lines DL1 to DL7 are equal to each other.

In some embodiments, the space for the microwave device 20 to irradiate the microwave power MP is huge and combined structure, and the slave generators SG1 to SG7 is distant away from the master generator MG2. As such, merely using a delay unit 130 disposed in the master generator MG1 may not have sufficient effective length to make the delayed master RF signal DS in phase with the delayed slave RF signals DS1 to DS7. Therefore, the external delay line EDL is applied and configured to maintain the delayed master RF signal DS and the delayed slave RF signals DS1 to DS7 in phase. In some embodiments, because the external delay line EDL is disposed external to the master generator MG2, a length of the external delay line EDL has higher design flexibility. In other words, the external delay line EDL can have various lengths which are designed to cope with the need of microwave device 20.

The phase shifter 140 is configured to receive the delayed master RF signal DS and generate an adjusted RF signal AS by adjusting a phase of the delayed master RF signal DS. In some embodiments, an amount of phase adjusted by the phase shifter 140 is set to 0 degree, which means that the phase value does not change. In such embodiments, the phase value of the adjusted RF signal AS is set to be a reference phase for other slaver generators SG1 to SG7. Alternatively, the phase shifter 140 has the ability to change the phase of the delayed master RF signal DS and also has the ability to maintain the phase of delayed master RF signal DS.

The attenuator 150 is configured to receive the adjusted RF signal AS and generate an attenuated RF signal ATTS by attenuating a power of the adjusted RF signal AS. The amplifier 160 is configured to receive the attenuated RF signal ATTS and generate the master RF output MO2 by amplifying the attenuated RF signal ATTS.

In some embodiments, the slave generators SG1 to SG7 in FIG. 9 are the same as those in FIG. 2. Therefore, the details of the slave generators SG1 to SG7 of the microwave device 20 are omitted for brevity.

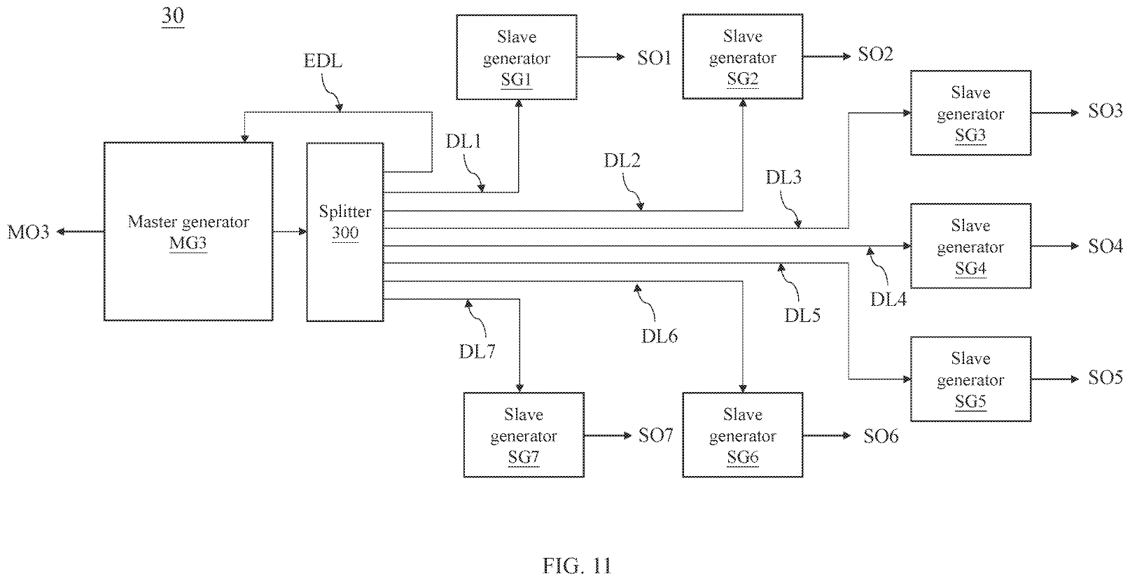

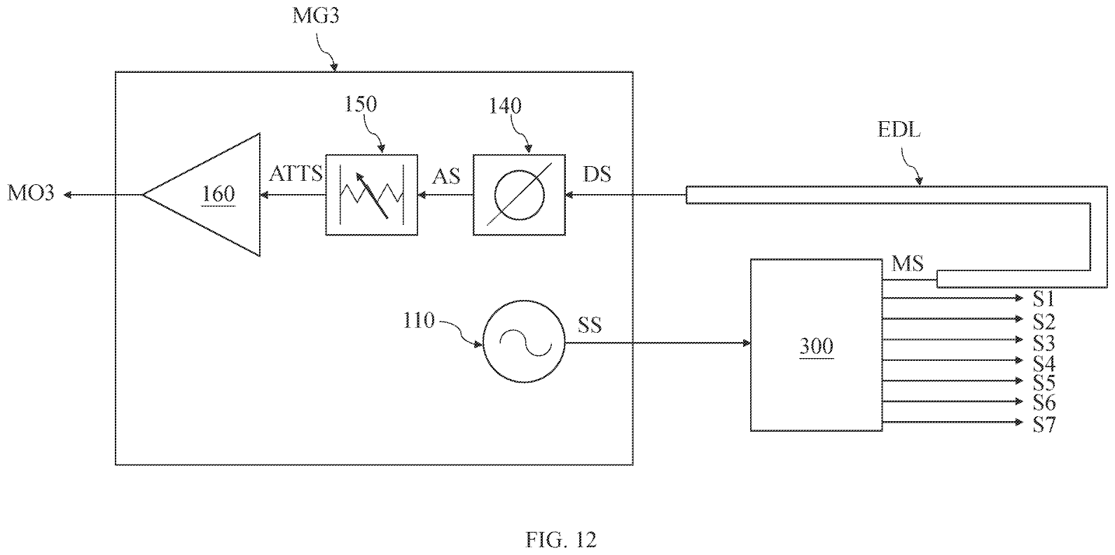

Reference is made to FIG. 11 and FIG. 12. FIG. 11 is a schematic diagram of a microwave device 30 according to some embodiments of the present disclosure. FIG. 12 is a schematic diagram of a master generator MG3 according to some embodiments of the present disclosure.

The microwave device 30 is similar to the microwave device 10. More specifically, the microwave device 30 is configured to irradiate the microwave power MP to the object OB as illustrated in FIG. 1. Compared to the microwave device 10, the microwave device 30 includes a master generator MG3 different from the master generator MG1, a splitter 300, and an external delay line EDL coupled between the master generator MG3 and the splitter 300.

To facilitate understanding, reference numerals of similar components in the microwave device 30 are designated as the same reference numerals of those in the microwave device 10.

Similar to the master generator MG1, the master generator MG3 includes a PLL synthesizer 110, a phase shifter 140, an attenuator 150, and an amplifier 160.

The PLL synthesizer 110 is configured to generate a source RF signal SS. After the source RF signal SS is generated, the master generator MG3 is configured to transmit the source RF signal SS to the splitter 300. It should be noted that the splitter 300 is an element separated from the master generator MG3. Alternatively stated, the splitter 300 is external to the master generator MG3.

The splitter 300 is configured to receive the source RF signal SS and generate a master RF signal MS and slave RF signals S1 to S7 by splitting the source RF signal SS. In some embodiments, the splitter 300 is similar to the splitter 120 shown in FIG. 5.

In some embodiments, a frequency of the source RF signal SS is identical to a frequency of the master RF signal MS and a frequency of each of the slave RF signals S1 to S7, and a power of the source RF signal SS is identical to a power of the master RF signal MS and a power of each of the slave RF signals S1 to S7. Furthermore, the master RF signal MS and each of the slave RF signals S1 to S7 are in phase.

Compared to the master generator MG1, the master generator MG3 does not includes a delay unit 130 and the splitter 120, however, the microwave device 30 further includes the splitter 300 and the external delay line EDL coupled between the splitter 300 and the master generator MG3.

The external delay line EDL is configured to receive the master RF signal MS and generate a delayed master RF signal DS by delaying the master RF signal MS. The delay lines DL1 to DL7 are configured to delay the slave RF signals S1 to S7 and generate the delayed slave RF signals DS1 to DS7, respectively. The delayed master RF signal DS and the delayed slave RF signals DS1 to DS7 are in phase. In order to maintain the delayed master RF signal DS and the delayed slave RF signals DS1 to DS7 in phase at different frequency, a length of the external delay line EDL and lengths of the delay lines DL1 to DL7 are equal to each other.

The phase shifter 140 is configured to receive the delayed master RF signal DS and generate an adjusted RF signal AS by adjusting a phase of the delayed master RF signal DS. In some embodiments, an amount of phase adjusted by the phase shifter 140 is set to 0 degree, which means that the phase value does not change. In such embodiments, the phase value of the adjusted RF signal AS is set to be a reference phase for other slaver generators SG1 to SG7. Alternatively, the phase shifter 140 has the ability to change the phase of the delayed master RF signal DS and also has the ability to maintain the phase of delayed master RF signal DS.

The attenuator 150 is configured to receive the adjusted RF signal AS and generate an attenuated RF signal ATTS by attenuating a power of the adjusted RF signal AS. The amplifier 160 is configured to receive the attenuated RF signal ATTS and generate the master RF output MO3 by amplifying the attenuated RF signal ATTS.

In some embodiments, the slave generators SG1 to SG7 in FIG. 11 are the same as those in FIG. 2. Therefore, the details of the slave generators SG1 to SG7 of the microwave device 30 are omitted for brevity.

In some embodiments, the microwave device 10, 20 and 30 are configured to generate a KW microwave power MP. For example, a power of each of the master RF output MO1, MO2, and MO3 is about 250 watt, and a power of each of the slave RF output SO1 to SO7 is about 250 watt. In this situation, a power of the microwave power MP is about 2 KW.

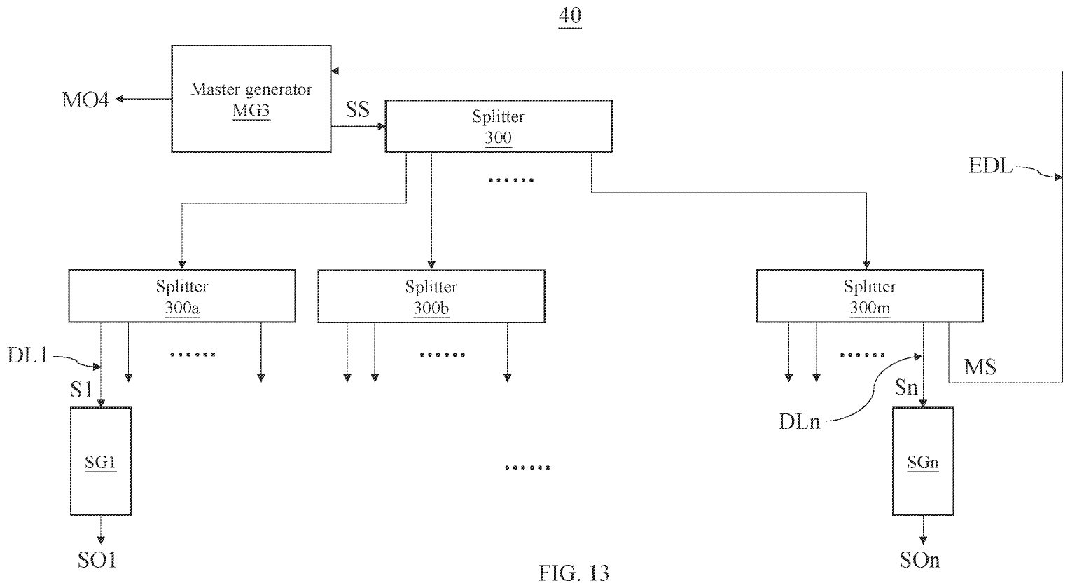

In other embodiments, a microwave device may need a higher power to heat the object OB. In this situation, the microwave device may have more slave generators to increase the total power of the output, such as a microwave device 40 illustrated in FIG. 13.

Reference is made to FIG. 13. FIG. 13 is a schematic diagram of the microwave device 40 according to other embodiments of the present disclosure.

The microwave device 40 is similar to the microwave device 30. More specifically, the microwave device 40 is configured to irradiate the microwave power MP to the object OB as illustrated in FIG. 1. The microwave device 40 includes a master generator MG3 and a splitter 300 which are the same as the master generator MG3 and a splitter 300 of the microwave device 30. The microwave device 40 further includes splitters 300a to 300m, delay lines DL1 to DLn, an external delay line EDL, and slave generators SG1 to SGn. The numerals in subscript, i.e., m and n, are integers, and n is greater than m.

The splitters 300a to 300m are similar to the splitter 300, and the internal elements in each of the splitters 300a to 300m are the same as the elements in the splitter 300. As illustrated in FIG. 13, the splitters 300a to 300m are coupled to the splitter 300.

The master generator MG3 is configured to generate the source RF signal SS to the splitter 300, and the splitter 300 is configured to split the source RF signal SS and transmit the same to the splitters 300a to 300m.

The splitters 300a to 300m are configured to split the received signal so as to generate slave RF signals S1 to Sn and the master RF signal MS. The slave RF signals S1 to Sn are transmitted to the slave generators SG1 to SGn, respectively. The master RF signal MS is transmitted through the external delay line EDL to the master generator MG3. The master generator MG3 is configured to generate a master RF output MO4 according to the master RF signal MS, and the slave generators SG1 to SGn are configured to generate slave RF outputs SO1 to SOn according to the slave RF signals S1 to Sn, respectively.

In some embodiments, each of the slave generators SG1 to SGn is the same as the slave generator SG1 of the microwave device 10, 20, or 30. Therefore, the details of the slave generators SG1 to SGn are omitted for brevity.

In some embodiments, a length of the external delay line EDL is the same as a length of each of the delay lines DL1 to DLn. In some embodiments, the master RF output MO4 and the slave RF output SO1 to SOn are in phase.

The microwave device 40 is able to generate a microwave power MP having higher energy. In the embodiments shown in FIG. 13, the output power of the microwave power MP is equal to n+1 times of the 250 W. For example, when the n is equal to 63, the output power of the microwave power MP is about 16 KW. For another example, when the n is equal to 2047, the output power of the microwave power MP is about 2 MW. It should be noted that the present disclosure is not limited to 63, in various embodiments, n can be any integers.

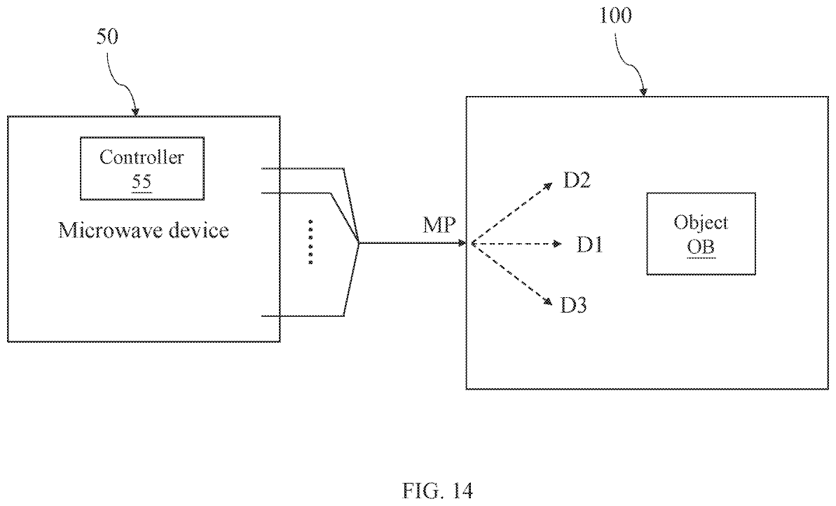

Reference is made to FIG. 14. FIG. 14 is a schematic diagram of a microwave device 50 according to some embodiments of the present disclosure.

In some embodiments, the microwave device 50 is configured to irradiate the microwave power MP to the object OB. Moreover, the microwave device 50 is further configured to scan the object OB by changing an irradiating direction D1 when irradiating the microwave power MP.

The microwave device 50 includes the microwave device 10, 20, 30, or 40. To facilitate understanding, the microwave device 50 is described based on the embodiment that the microwave device 50 includes the microwave device 10.

The microwave device 50 further includes a controller 55 configured to control the phase shifter 140 of the master generator MG1 and the phase shifter 240 of each of the slave generators SG1 to SG7.

In some embodiments, when the phase of the master RF output MO1 and the phase of each of the slave RF output SO1 to SO7 are determined, the irradiating direction D1 is determined. In other words, when the phase is fixed at a certain value, the irradiating direction D1 is fixed at a certain direction as well.

The microwave device 50 is configured to change the irradiating direction D1 by using the controller 55. More specifically, the controller 55 is configured to transmit control signals to the phase shifter 140 of the master generator MG1 and the phase shifter 240 of each of the slave generators SG1 to SG7, so as to control the amount of phase adjust by the phase shifter 140 of the master generator MG1 and the phase shifter 240 of each of the slave generators SG1 to SG7. Accordingly, the phase of the master RF output MO1 and the slave RF outputs SO1 to SO7 are changed.

The microwave device 50 performs the beam forming to generate the microwave power MP and determines the irradiating direction D1 according to the phase of the master RF output MO1 and the slave RF outputs SO1 to SO7. When the phase of the master RF output MO1 and the slave RF outputs SO1 to SO7 are changed, the irradiating direction D1 may be changed to an irradiating direction D2 or an irradiating direction D3.

It should be noted that the irradiating directions D1 to D3 are provided for illustrative purposes. The present disclosure is not limited thereto. In other embodiments, the microwave device 50 is configured to irradiate the microwave power MP along arbitrary direction. In various embodiments, the microwave device 50 is configured to irradiate the microwave power MP by scanning from the irradiating direction D1 to the irradiating direction D2.

In some embodiments, the microwave generators MG1, MG2, and MG3 and the slave generators SG1 to SGn are solid state microwave generators. In some conventional approaches, although the magnetron tube is able to generate a microwave having high power, the spectrum of the microwave generated by the magnetron tube includes various frequency which result that the microwave is hard to control. By using the solid state microwave generators, the frequency, the power, and the phase of the microwave are more controllable than those in the conventional approaches. Therefore, the microwave devices 10 to 50 provided by the present disclosure suitable for high power generation with high controllability.

Another aspect of the present disclosure provides a microwave device including a master generator, an external delay line, delay lines, and slave generators. The master generator is configured to generate split signals and generate a master RF output. The external delay line is coupled to the master generator. The delay lines are coupled to the master generator. The slave generators are coupled to the master generator through the delay lines and configured to generate slave RF outputs according to a source RF signal, respectively. The master generator is configured to receive a first split signal of the split signals so as to generate the master RF output, and the slave generators are configured to receive the rest of the split signals other than the first split signal so as to generate the slave RF output, respectively.

Yet another aspect of the present disclosure provides a microwave device including a master generator, a splitter, delay lines, and slave generators. The master generator is configured to generate a source RF signal. The splitter is coupled to split the source RF signal to split signals. The delay lines are configured to delay the split signals so as to generate delayed signals. The delayed signals includes a master RF signal and slave RF signals. The master generator is configured to generate a master RF output according to the master RF signal, and the slave generators are respectively configured to generate slave RF outputs according to the slave RF signals. Each of the delay lines has a length equal to each other.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, and steps.

What is claimed is:

1. A microwave device, comprising:
a master generator, configured to generate a source radio frequency (RF) signal so as to generate a master RF output;
a plurality of delay lines, coupled to the master generator; and
a plurality of slave generators, coupled to the master generator through the plurality of delay lines and configured to generate a plurality of slave RF outputs according to the source RF signal, respectively,
wherein the master RF output and the plurality of slave RF outputs are in phase.

2. The microwave device of claim 1, wherein each of the plurality of delay lines has a length equal to each other.

3. The microwave device of claim 1, wherein the master generator comprises:
a phase-locked loop (PLL) synthesizer, configured to generate the source RF signal;
a splitter, configured to generate a master RF signal and a plurality of slave RF signals;
a delay unit, configured delay the master RF signal so as to generate a delayed master RF signal;
a master phase shifter, configured adjust a phase of the delayed master RF signal so as to generate an adjusted RF signal;
a master attenuator, configured to attenuate a power of the adjusted RF signal so as to generate an attenuated RF signal; and
a master amplifier, configured to amplify the attenuated RF signal so as to generate the master RF output.

4. The microwave device of claim 3, wherein the plurality of delay lines are coupled to the splitter, and configured to delay the plurality of slave RF signals so as to generate a plurality of delayed slave RF signals, respectively,
wherein the plurality of slave generators is configured to receive the plurality of delayed slave RF signals, respectively.

5. The microwave device of claim 4, wherein the delay master RF signal and each of the plurality of delayed slave RF signals are in phase.

6. The microwave device of claim 3, wherein each of the plurality of slave generators comprises:
a slave phase shifter, coupled to the respective delay line and configured to generate an adjusted slave RF signal according to the respective slave RF signal;
a slave attenuator, configured to attenuate a power of the adjusted slave RF signal so as to generate an attenuated slave RF signal; and
a slave amplifier, configured to amplify the attenuated slave RF signal so as to generate the respective slave RF output.

7. The microwave device of claim 3, wherein the splitter comprises:
a power control unit, configured to receive the source RF signal and control a power of the source RF signal; and
a coupler assembly array, coupled to the power control unit, and configured to generate the plurality of slave RF signals.

8. The microwave device of claim 7, wherein the power control unit comprises:
an attenuator, configured to receive the source RF signal; and
an amplifier, coupled between the attenuator and the coupler assembly array.

9. The microwave device of claim 1, wherein a power of the master RF output is identical to a power of each of the plurality of slave RF outputs.

10. A microwave device, comprising:
a master generator, configured to generate a plurality split signals and generate a master RF output;
an external delay line, coupled to the master generator;
a plurality of delay lines, coupled to the master generator; and
a plurality of slave generators, coupled to the master generator through the plurality of delay lines and configured to generate a plurality of slave RF outputs according to a source RF signal, respectively,
wherein the master generator is configured to receive a first split signal of the plurality of split signals so as to generate the master RF output, and the plurality of slave generators are configured to receive the rest of the plurality of split signals other than the first split signal so as to generate the plurality of slave RF output, respectively.

11. A microwave device, comprising:
a master generator, configured to generate a source RF signal;
a splitter, coupled to split the source RF signal to a plurality of split signals;
a plurality of delay lines, configured to delay the plurality of split signals so as to generate a plurality of delayed signals; and
a plurality of slave generators,
wherein the plurality of delayed signals comprises a master RF signal and a plurality of slave RF signals, wherein the master generator is configured to generate a master RF output according to the master RF signal, and the plurality of slave generators are configured to generate a plurality of slave RF outputs according to the plurality of slave RF signals, respectively,
wherein each of the delay lines has a length equal to each other.

12. The microwave device of claim 11, wherein the master RF output and the plurality of slave RF outputs are in phase.

13. The microwave device of claim 11, wherein the master generator comprises:
a PLL synthesizer, configured to generate the source RF signal;
a master phase shifter, configured adjust a phase of the master RF signal so as to generate an adjusted RF signal;
a master attenuator, configured to attenuate a power of the adjusted RF signal so as to generate an attenuated RF signal; and
a master amplifier, configured to amplify the attenuated RF signal so as to generate the master RF output.

14. The microwave device of claim 11, wherein each of the plurality of slave generators comprises:
a slave phase shifter, configured to generate an adjusted slave RF signal according to the respective slave RF signal;
a slave attenuator, configured to attenuate a power of the adjusted slave RF signal so as to generate an attenuated slave RF signal; and
a slave amplifier, configured to amplify the attenuated slave RF signal so as to generate the respective slave RF output.

15. The microwave device of claim 14, further comprising:
a controller, configured to control the slave phase shifter of each of the plurality of slave generators so as to adjust a phase of each of the adjusted slave RF signal.

16. The microwave device of claim 11, wherein the microwave device is configured to perform a beam forming to irradiate the master RF output and the plurality of slave RF outputs along a direction.

17. The microwave device of claim 16, wherein the direction is associated with a phase of the master RF output and a phase of each of the plurality of slave RF outputs.

18. The microwave device of claim 11, wherein each of the plurality of split signals has a power equal to each other.

19. The microwave device of claim 11, wherein each of the plurality of split signals has a power equal to a power of the source RF signal.

20. The microwave device of claim 11, wherein the master generator and the plurality of slave generators are solid state microwave generators.
